(19) United States
(12) Patent Application Publication
(10) Pub. No.: US 2018/0012570 A1
(43) Pub. Date: Jan. 11, 2018

(54) APPARATUS AND METHOD FOR MAPPING FRAME BUFFERS TO LOGICAL DISPLAYS

(71) Applicant: Futurewei Technologies, Inc., Plano, TX (US)

(72) Inventors: Fangqi Hu, San Diego, CA (US); Pingfang Zheng, San Diego, CA (US); Tongzeng Yang, San Diego, CA (US); Haibo Zhong, San Diego, CA (US); Zhiping Jia, San Diego, CA (US)

(21) Appl. No.: 15/642,089

(22) Filed: Jul. 5, 2017

Related U.S. Application Data
(60) Provisional application No. 62/359,651, filed on Jul. 7, 2016.

(51) Int. Cl. G09G 5/395; G06F 3/14; G06T 1/60; G06T 1/20

(52) U.S. Cl. CPC G09G 5/395; G06T 1/60; G06F 3/1423; G06T 1/20; G09G 2360/18

(57) ABSTRACT

A processing device, computer program, and method are provided for mapping frame buffers to a plurality of logical displays. A plurality of frame buffers are identified which are each associated with different parameters. The frame buffers are mapped to a plurality of logical displays, based on the different parameters. A display of contents of the frame buffers mapped to the logical displays is caused utilizing at least one physical display.

### RELATED APPLICATION(S)

The present application claims priority to a provisional application filed on Jul. 7, 2016, under Application Ser. No. 62/359,651, which is incorporated herein by reference in its entirety for all purposes.

### FIELD OF THE INVENTION

The present invention relates to display systems, and more particularly to display sub-systems that perform processing in advance of display.

### BACKGROUND

Typically, devices are equipped with one main physical display. Some devices, however, have one smaller secondary display. In use, for a device with a main physical display, each application requests a frame buffer to hold contents (e.g. image, frame, etc.) to be displayed on the main physical display, and updated contents are submitted to a display sub-system. The display sub-system, in turn, takes such filled frame buffers, and composes a final display image, and sends the composited contents to the appropriate physical display.

The foregoing architecture exhibits some drawbacks. Specifically, in a situation where: 1) applications require the display of contents on different physical displays and/or 2) an application requires one part of a frame buffer to be displayed on a first physical display and another part to be displayed on a different physical display, typical systems may not necessarily be able to support the same from a system architecture perspective. Examples of such a situation (implicating 1) and 2) above) may involve a video conference call where a display system architecture is not able to smoothly support a way to present a video portion using a first physical display, and textual information using a second physical display.

Thus, prior art display sub-systems exhibit an inflexibility and/or inefficient use of resources in situations like that noted above.

### SUMMARY

An apparatus, computer program, and method are provided for mapping frame buffers to a plurality of logical displays. A plurality of frame buffers are identified which are each associated with different parameters. The frame buffers are mapped to a plurality of logical displays, based on the different parameters. A display of contents of the frame buffers mapped to the logical displays is caused utilizing at least one physical display.

In a first embodiment, the frame buffers may each be associated with at least one of a plurality of different applications for generating the contents of the frame buffers.

In a second embodiment (which may or may not be combined with the first embodiment), the different parameters may include frame rate, gamma, gamut, resolution, one or more pixel data transmission rate requirements, one or more image processing feature set requirements, and/or a brightness.

In a third embodiment (which may or may not be combined with the first and/or second embodiments), the frame buffers may be mapped to the logical displays based on the different parameters, by mapping a first one or more of the frame buffers associated with a first parameter to a first one of the logical displays associated with the first parameter, and mapping a second one or more of the frame buffers associated with a second parameter to a second one of the logical displays associated with the second parameter.

In a fourth embodiment (which may or may not be combined with the first, second, and/or third embodiments), the frame buffers may be mapped to the logical displays based on the different parameters, by grouping the frame buffers into a plurality of groups, based on the different parameters, and mapping the groups of the frame buffers to the logical displays.

In a fifth embodiment (which may or may not be combined with the first, second, third, and/or fourth embodiments), image processing may be performed on the contents of the frame buffers. As an option, the image processing may be performed before the frame buffers are mapped to the logical displays. Further, the image processing may be performed based on the logical displays to which the frame buffers are mapped, and/or one or more of the different parameters.

In a sixth embodiment (which may or may not be combined with the first, second, third, fourth, and/or fifth embodiments), composition may be performed on the contents of the frame buffers. Such composition may be performed utilizing a graphics processor and/or dedicated composition hardware. Further, the composition may be performed after the frame buffers are mapped to the logical displays. Still yet, first results of the composition involving a first number of the frame buffers may be combined with second results of another composition involving a second number of the frame buffers.

In a seventh embodiment (which may or may not be combined with the first, second, third, fourth, fifth, and/or sixth embodiments), the contents of the frame buffers mapped to the logical displays may be caused to be displayed utilizing different regions of a single physical display. Still yet, the contents of the frame buffers mapped to the logical displays may be caused to be displayed utilizing different physical displays.

To this end, in some optional embodiments, one or more of the foregoing features of the aforementioned apparatus, computer program, and/or method may provide flexible support to embodiments involving multiple physical displays since each logical display can be mapped to one or more physical displays. Further, each logical display may independently perform compositions according to its own parameters (e.g. frame rate, etc.). By this feature, a number of compositions may be reduced and, for each composition, a number of involved frame buffers may also be reduced. In one embodiment, such reduction in compositions may translate into a reduction in computations with a corresponding reduction in power usage. In addition, one or more of the foregoing features may also reduce a necessary memory footprint, reduce a system response time, and allow a different set of image processing features to be independently applied to different logical displays and a corresponding one or more physical displays. It should be noted that the aforementioned potential advantages are set forth for illustrative purposes only and should not be construed as limiting in any manner.

### BRIEF DESCRIPTION OF THE DRAWINGS

FIG. 1 illustrates a method for mapping frame buffers to a plurality of logical displays, in accordance with one embodiment.

FIG. 2A illustrates a system for mapping frame buffers to a plurality of logical displays, in accordance with one embodiment.

FIG. 2B illustrates another system for mapping frame buffers to a plurality of logical displays, in accordance with another embodiment.

FIG. 3 illustrates a method for mapping frame buffers to a plurality of logical displays, in accordance with one embodiment.

FIG. 4 illustrates an exemplary mapping, in accordance with one embodiment.

FIG. 5 illustrates a system for performing composition on multiple frame buffers, in accordance with one exemplary embodiment.

FIG. 6 illustrates a network architecture, in accordance with one embodiment.

FIG. 7 illustrates an exemplary system, in accordance with one embodiment.

### DETAILED DESCRIPTION

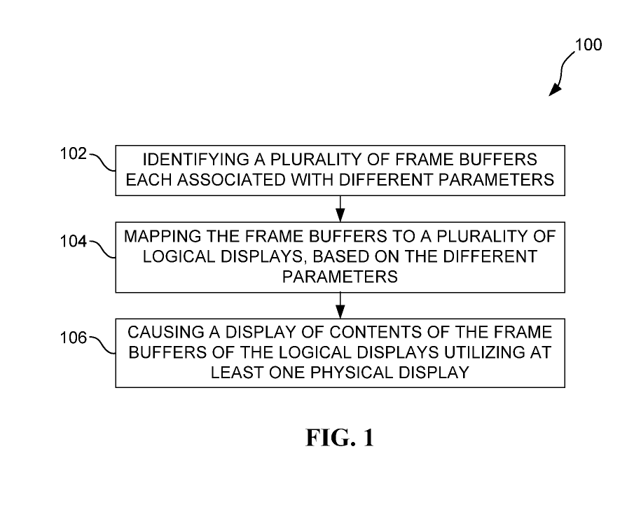

FIG. 1 illustrates a method 100 for mapping frame buffers to a plurality of logical displays, in accordance with one embodiment. In the context of the present description, such frame buffers may include any logical and/or physical memory that are configured for including contents such as pixel information, frame information, display information, and/or other information generated and/or used for processing in advance of a presentation thereof via a display. Non-exhaustive examples of the aforementioned contents may include, but is not limited to color/lighting values, geometric/position values, and/or any other data, for that matter.

In one possible embodiment, the frame buffers may each be associated with at least one of a plurality of different applications that serve to generate the contents of the frame buffers. Further, in different optional embodiments, the frame buffers may be implemented utilizing any desired memory including, but not limited to general purpose memory, video adapter memory, graphics processor memory, and/or any other suitable memory. Further examples of memory will be set forth later during the description of subsequent embodiments.

Also in the context of the present description, the logical displays may each refer to any data structure, logical and/or physical memory, and/or logic that stores or tracks one or more of the frame buffers. In various embodiments, the logical displays may or may not be stored using the same aforementioned memory used for implementing the frame buffers. More information regarding various optional features of the logical displays will be set forth later in greater detail.

With reference to FIG. 1, a plurality of frame buffers are identified in operation 102 which are each associated with different parameters. In the context of the present description, the different parameters may include any aspect of graphics processing and/or subsequent display. For example, in various optional embodiments, the different parameters may include frame rate, gamma, gamut, resolution, one or more pixel data transmission rate requirements, one or more image processing feature set requirements, and/or brightness.

In one possible embodiment, image processing may be performed on the contents of the frame buffers. In the context of the present description, such image processing may include any processing of at least a portion of the contents of the frame buffers for improving and/or enhancing an ultimate display thereof via at least one physical display. Just by way of example, such image processing may involve filtering, noise reduction, smoothing, contrast stretching, edge enhancement, restoration, and/or any other type of processing that meets the above definition.

In one embodiment, the foregoing image processing may be performed before the frame buffers are mapped to the logical displays (or any other desired time, for that matter). Further, in various embodiments, the image processing may be performed based on the logical displays to which the frame buffers are mapped, and/or one or more of the parameters. For instance, the image processing that is performed may be selected to accommodate a specific one or more of the parameters corresponding to the frame buffers (e.g. based on the contents thereof, etc.) and/or the logical displays, so as to accommodate such parameters. Just by way of example, if one of the frame buffers/logical displays is associated with a high frame rate, the image processing may involve an interpolation between frames to generate extra frames to accommodate such high frame rate.

In operation 104, the frame buffers are mapped to a plurality of logical displays, based on the different parameters. In the present description, such mapping may refer to any association of one or more of the frame buffers in connection with at least one of the logical displays, that enables the display of frame buffer contents mapped to the logical displays utilizing at least one physical display, in a manner that will soon become apparent.

For example, in one possible embodiment, the frame buffers may be mapped to the logical displays, by mapping a first one or more of the frame buffers associated with a first parameter to a first one of the logical displays associated with the first parameter. Further, a second one or more of the frame buffers associated with a second parameter may be mapped to a second one of the logical displays associated with the second parameter. Thus, in the present embodiment, specific parameters may be associated with both the frame buffers and the logical displays so that they may be mapped (e.g. matched, etc.) based on a common one or more parameters.

In another embodiment, the frame buffers may be mapped to the logical displays, by grouping the frame buffers into a plurality of groups, based on the different parameters. For instance, the frame buffers may be grouped based on the parameters such that resultant groups of the frame buffers have a common one or more parameters. To this end, the groups of the frame buffers may be mapped to the logical displays which have the corresponding parameters.

In one optional embodiment, composition may be performed on the contents of the frame buffers. In the context of the present description, such composition may refer to any process that puts together the contents from the frame buffers, so as to create one or more images/frames (or portion thereof), prior to display. Such composition may be performed utilizing a graphics processor and/or dedicated composition hardware. Further, the composition may be performed after the frame buffers are mapped to the logical displays in operation 106. Still yet, by virtue of the fact that different frame buffers are split between different logical displays (and thus the contents of one or more images/frames (or portion(s) thereof) are also split), multiple instances of composition may be employed. For example, first results of the foregoing composition involving a first number of the frame buffers may be combined with second results of another composition involving a second number of the frame buffers.

To this end, in operation 106, a display of contents of the frame buffers mapped to the logical displays is caused utilizing at least one physical display. In the context of the present description, the at least one physical display may include any physical screen capable of displaying the contents of the frame buffers. For example, the at least one physical display may include a computer monitor, television, mobile device screen, and/or any other display. Further, the displaying of operation 106 may be caused in any desired manner that results in such display. For example, such causation may include a generation and/or transmission of a display-related command via an interface, sending the contents over the interface which, in turn, prompts the display, etc.

It should be noted that various embodiments are contemplated where the display may be caused utilizing a single physical display or multiple physical displays (e.g. 2, 3, 4 . . . N, etc. physical displays). Thus, in one embodiment, the contents of the frame buffers mapped to the logical displays may be caused to be displayed utilizing different regions of a single physical display.

Still yet, in other embodiments, the contents of the frame buffers mapped to the logical displays may be caused to be displayed utilizing different physical displays. In such embodiment, the method 100 may provide flexible support to embodiments involving multiple physical displays since each logical display can be mapped to one or more physical displays. Specifically, in a situation where: 1) applications require the display of image contents on different physical displays and/or 2) applications require one part of a frame buffer to be displayed via a first physical display and another part to be displayed via a different physical display, a system without the aforementioned logical displays may not necessarily be able to support the same from a system architecture perspective. Examples of such a situation (implicating 1) and 2) above) may involve a video conference call where a display system architecture is not able to smoothly support a way to present a video portion using a first physical display, and textual information using a second physical display. However, by allowing different frame buffer contents to be mapped to different logical displays which, in turn, may be mapped to different physical displays (and/or display regions thereof), the aforementioned flexibility is afforded.

Still yet, in some optional embodiments, one or more of the foregoing features may allow each logical display to independently perform compositions according to its own parameters (e.g. frame rate, etc.). By this feature, a number of compositions may be reduced and, for each composition, a number of involved frame buffers may also be reduced. In one embodiment, such reduction in compositions may translate into a reduction in computations with a corresponding reduction in power usage.

For example, in a situation where there are three (3) applications A, B, and C; each application may allocate two (2) frame buffers for image contents: A1, A2, B1, B2, C1, and C2. Whenever there is an update needed from one of the buffers, or when a display sub-system determines that it needs an update to a physical display; such system may perform a composition for all the buffers of A1, A2, B1, B2, C1, and C2; and send the composition result to the physical display. This has a negative impact for overall system performance, since, when there is an update in only one frame buffer, all the frame buffers are composited to update the physical display. However, by dividing the foregoing frame buffers into different groups associated with different logical displays, the aforementioned composition (and/or any other processing, for that matter) may be more selectively applied to only frame buffer contents that are in actual need of such composition/processing.

In addition, one or more of the foregoing features may also reduce a necessary memory footprint. In particular, lower frame rate applications require less frame buffers than higher frame rate applications. For example, when the frame rate is low, the display system architecture may just need double-buffering, but when the frame rate is high, it may need triple-buffering. By using multiple logical displays, such a system can systematically may the frame buffers associated with low frame rates to logical displays that use only double-buffering (instead of triple-buffering), thereby reducing an overall amount of required memory.

Still yet, one or more of the foregoing features may also reduce a system response time. Specifically, using the multiple logical displays, each required composition may be configured to only involve a subset of the frame buffers in a particular group. This may, in turn, reduce use of computation resources which may translate into an improved response time.

Even still, one or more of the foregoing features may also allow different sets of image processing features to be independently applied to different logical displays and a corresponding one or more physical displays, as set forth above. By selectively applying image processing only where needed, additional processing/power resources are conserved and/or available for being applied elsewhere.

More illustrative information will now be set forth regarding various optional architectures and uses in which the foregoing method may or may not be implemented, per the desires of the user. It should be noted that the following information is set forth for illustrative purposes and should not be construed as limiting in any manner. Any of the following features may be optionally incorporated with or without the exclusion of other features described.

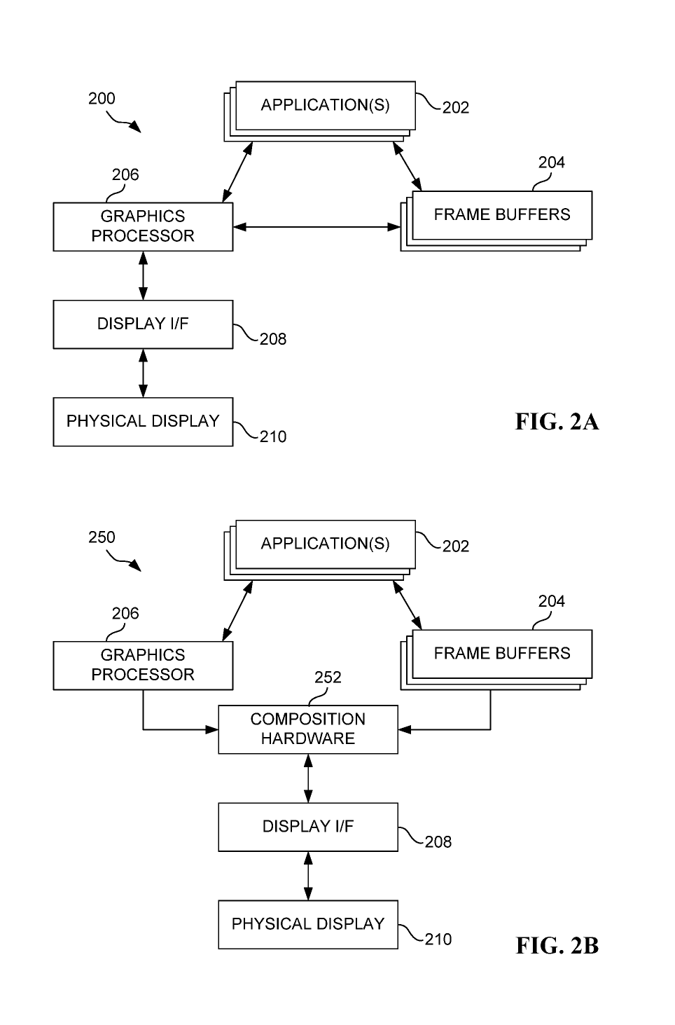

FIG. 2A illustrates a system 200 for mapping frame buffers to a plurality of logical displays, in accordance with one embodiment. As an option, the system 200 may incorporate any one or more features of any one or more of the embodiments set forth in any previous and/or subsequent figure(s) and/or the description thereof. However, it is to be appreciated that the system 200 may be implemented in the context of any desired environment.

As shown, the system 200 includes a plurality of applications 202 that produce content for being processed and displayed. In various embodiments, the applications 202 may each include, but is not limited to a word processor, a spreadsheet processor, a communication (e.g. email, instant message, etc.) manager, an Internet browser, a file manager, an on-line store application, a client for a network-based application/service, and/or any other software that is capable of generating content capable of being processed for display.

With continuing reference to FIG. 2A, the applications 202 remain in communication with a plurality of frame buffers 204 and a graphics processor 206 which, in turn, remains in communication with the frame buffers 204. During use, the applications 202 request (e.g. have allocated, etc.) one or more of the frame buffers 204 for storing the aforementioned content being generated, for display-related processing. Further, in response to requests from the applications 202, the graphics processor 206 populates (i.e. fills, etc.) the frame buffers 204 with the content, and further renders the contents of the frame buffers 204 (by creating a two- or three-dimensional image based on the context of the frame buffer 204).

In addition, the graphics processor 206 (or any other processor and/or circuit) may further map the frame buffers 204 to a plurality of logical displays (not shown) that are stored in internal memory (not shown) of the graphics processor 206 (or any other memory). Still yet, any additional image processing, composition, etc. may be performed by the graphics processor 206 (or any other processor and/or circuit), as well. To this end, an output of the graphics processor 206 (or any other processor and/or circuit) may be directed via a display interface 208 to one or more appropriate physical displays 210 and/or one or more regions thereof.

FIG. 2B illustrates another system 250 for mapping frame buffers to a plurality of logical displays, in accordance with another embodiment. As an option, the system 250 may incorporate any one or more features of any one or more of the embodiments set forth in any previous and/or subsequent figure(s) and/or the description thereof. However, it is to be appreciated that the system 250 may be implemented in the context of any desired environment.

Similar to the system 200 of FIG. 2A, the system 250 may include the applications 202, frame buffers 204, graphics processor 206, display interface 208, and physical display(s) 210, that operate in a similar manner. In contrast, however, the system 250 of FIG. 2B may include dedicated hardware 252 that may be used to perform the composition that the graphics processor 206 performed in the system 200 of FIG. 2A. It should be noted that the systems 200, 250 of FIGS. 2A/2B are set forth for illustrative purposes only and should not be construed as limiting in any manner whatsoever.

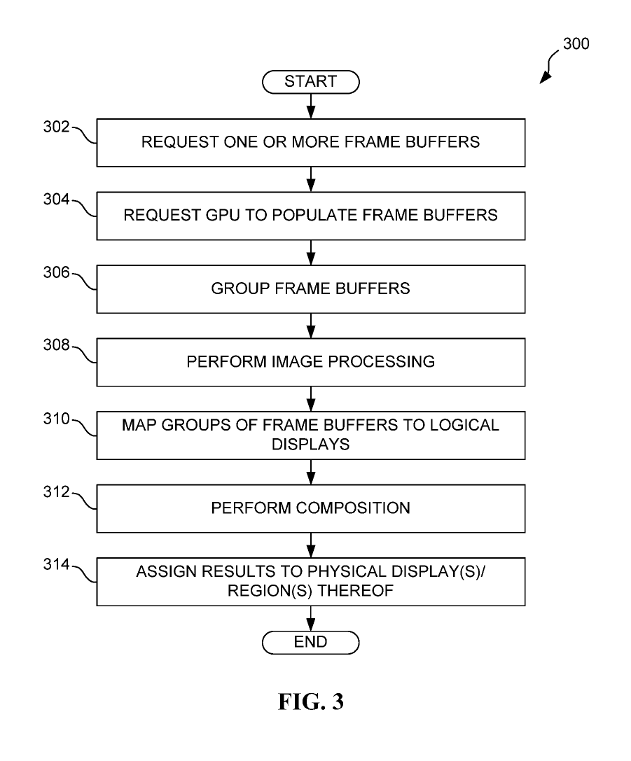

FIG. 3 illustrates a method 300 for mapping frame buffers to a plurality of logical displays, in accordance with one embodiment. As an option, the method 300 may be implemented in the context of any one or more of the embodiments set forth in any previous and/or subsequent figure(s) and/or description thereof. For example, in one embodiment, the method 300 may reflect an operation of one or more of the systems 200, 250 of FIGS. 2A/2B. However, it is to be appreciated that the method 300 may be implemented in the context of any desired environment.

As shown, one or more frame buffers (e.g. frame buffers 204 of FIGS. 2A/2B, etc.) are requested in operation 302. Such request may be received from one or more applications (e.g. applications 202 of FIGS. 2A/2B, etc.) and may further be directed to a graphics processor (e.g. graphics processor 2206 of FIGS. 2A/2B, etc.), the frame buffer, and/or any other entity that controls an allocation of the frame buffers for use.

Next, in operation 304, the graphics processor (or any other processor and/or circuit) may be requested to populate the frame buffers. In one embodiment, this may be accomplished by feeding and causing storage of the contents (possibly with some prior pre-processing) into the frame buffers that were allocated in operation 302. This may, in one embodiment, be effected through the use of specific commands issued by the graphics processor.

With continuing reference to FIG. 3, the frame buffers are grouped into a plurality of groups. See operation 306. In one embodiment, this may be accomplished by inspecting one or more parameters of the frame buffers. In various embodiments, the aforementioned one or more parameters may be gleaned from the contents of the frame buffers, assigned to the frame buffers via a parameter inspection and assignment procedure, and/or derived utilizing any other desired technique. By this design, the frame buffers with one or more common parameters may be grouped together. In one embodiment, the parameters that are the basis for such grouping may be those that are impacted by (e.g. affected by, require, etc.) different processing (e.g. image processing, composition, etc.) and/or different display capabilities, for reasons that will soon become apparent.

Next, in operation 308, image processing may be performed. In one embodiment, such image processing may be performed only on the contents of a subset of the groups of frame buffers, so as to only perform such processing on the contents that would benefit from the same (as well as conserve resources). This may be accomplished in any desired manner. For example, in one embodiment, different processing features may be flagged to be performed on only certain different frame buffers with suitable parameters. It should be noted that this may be carried out using a table, any desired logic, etc.

In operation 310, the groups of the frame buffers are mapped to logical displays. In one embodiment, this may be accomplished using any of the techniques that were set forth in the context of operation 104 of FIG. 1 and the description thereof. By this design, the logical displays may thus be associated with frame buffers with at least partially similar content (in terms of parameters) such that the relevant content may be more intelligently and flexibly applied to one or more physical display (and/or region(s) thereof).

Further, in operation 312, composition may then be performed to assemble the contents in a manner such that they are suitable for display. In one embodiment, such composition (and possibly different compositions) may be performed only on the contents of a subset of the groups of frame buffers, so as to only perform such composition(s) on the contents that would benefit from the same (as well as conserve resources). This may be accomplished in any desired manner. For example, in one embodiment, different composition may be flagged to be performed on only certain different frame buffers with suitable parameters. It should be noted that this may be carried out using a table, any desired logic, etc.

To this end, the results of the composition may be assigned to an appropriate one or more physical displays and/or one or more regions thereof. See operation 314. It should be noted that the order of the operations of the present method 300 is set forth for illustrative purposes only and should not be construed as limiting in any manner. For example, other embodiments are contemplated where the operations 308, 310, and 312 occur in different orders (and possibly repeatedly).

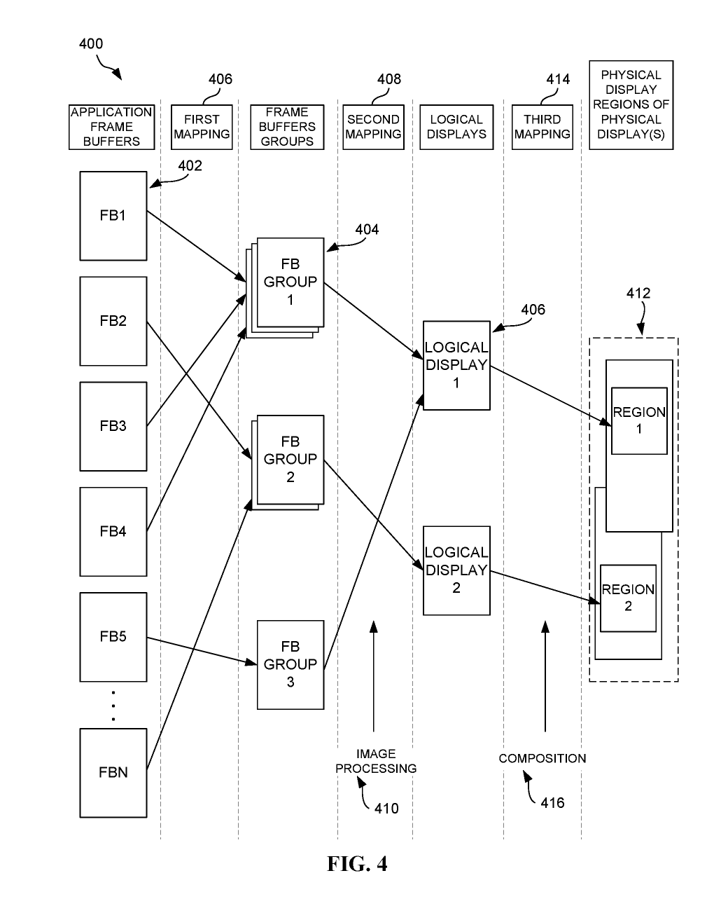

FIG. 4 illustrates an exemplary mapping 400, in accordance with one embodiment. As an option, the mapping 400 may be implemented in the context of any one or more of the embodiments set forth in any previous and/or subsequent figure(s) and/or description thereof. For example, in one embodiment, the mapping 400 may reflect an operation of one or more of the systems 200, 250 of FIGS. 2A/2B. However, it is to be appreciated that the mapping 400 may be implemented in the context of any desired environment.

As shown, a plurality of frame buffers 402 are mapped to a plurality of frame buffer groups 404 via a first mapping 406. Such frame buffer groups 404 are then mapped to a plurality of logical displays 406 via a second mapping 408. As an option, various image processing 410 may be performed prior to the second mapping 408.

Still yet, the logical displays 406 are then mapped to one or more physical displays 412 via a third mapping 414. In some embodiments, such third mapping 414 may be directed to different regions of two different physical displays 412, as shown. As various options, such different regions may correspond to just a portion, or an entirety, of the respective different physical displays 412. Further, it should be noted that other embodiments are contemplated where the third mapping 414 results in a mapping to different regions of a single physical display 412. As a further option, composition 416 may be performed in advance of the third mapping 414.

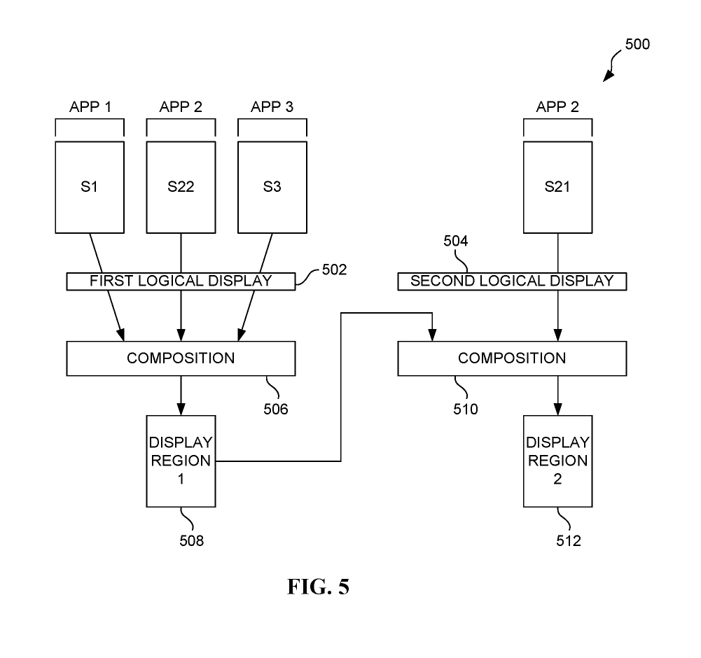

FIG. 5 illustrates a system 500 for performing composition on multiple frame buffers, in accordance with one exemplary embodiment. As an option, the system 500 may be implemented in the context of any one or more of the embodiments set forth in any previous and/or subsequent figure(s) and/or description thereof. However, it is to be appreciated that the system 500 may be implemented in the context of any desired environment.

As shown, a plurality of applications APP1, APP2, APP3 are provided. Specifically, in the context of the present example, a first application APP1 may be a background-running application that generates a status bar on a top of a screen, a second application APP2 may be conference streaming software that generates video in a middle of the screen and status information in other areas, and a third application APP3 may be an operating system that generates a system navigation bar at a bottom of the screen.

During use, such applications APP1, APP2, APP3 may generate contents for populating a plurality of frame buffers S1, S21, S22, S3. Specifically, the first application APP1 may request a first frame buffer S1 for the status information, the second application APP2 may request a second frame buffer S21 for a video component of its output and a third frame buffer S22 for an information component of its output, and the third application APP3 may request a fourth frame buffer S3 for the system navigation status.

In the context of the present exemplary system 500, all of the aforementioned content except the video may be “slower changing” requiring only a slower frame rate (e.g. 30 Hz, etc.) while the other content may be “faster changing” requiring a faster frame rate (e.g. 60 Hz, etc.). To leverage such distinction, the first frame buffer S1, the third frame buffer S22, and the fourth frame buffer S3 may be mapped to a first logical display 502, and the second frame buffer S21 may be mapped to a second logical display 504.

By this design, contents of a subset of the frame buffers S1, S22, S3 may be directed to a first composition process 506 that supports a first display region 508 by utilizing a composition rate of 30 Hz (i.e. every 33.3 ms) when performing a composition on the frame buffers S1, S22, S3. In contrast, contents of the second frame buffer S21 may be directed to a second composition process 510 that supports a second display region 512 by utilizing a composition rate of 60 Hz (i.e. every 16.6 ms) when performing a composition on the second frame buffer S21. Further, as shown, the results of the two composition processes 506, 510 may be combined (e.g. assembled) as shown for display via the physical display(s).

By this design, each of a plurality of logical displays may be mapped to one or more physical display regions, on one or more physical displays. For example, in one embodiment, a logical display may be used for all video playing or gaming which requires a high frame rate, high resolution, and/or high color brightness; and another logical display may be defined for a smaller frame rate, with lower resolution. Still yet, the application may request different content areas on different logical displays. For example, a browser application with embedded video playing may allocate the video playing into a higher frame rate logical display, while other text-oriented content (or other slower-changing content) may be allocated into a logical display with a lower frame rate.

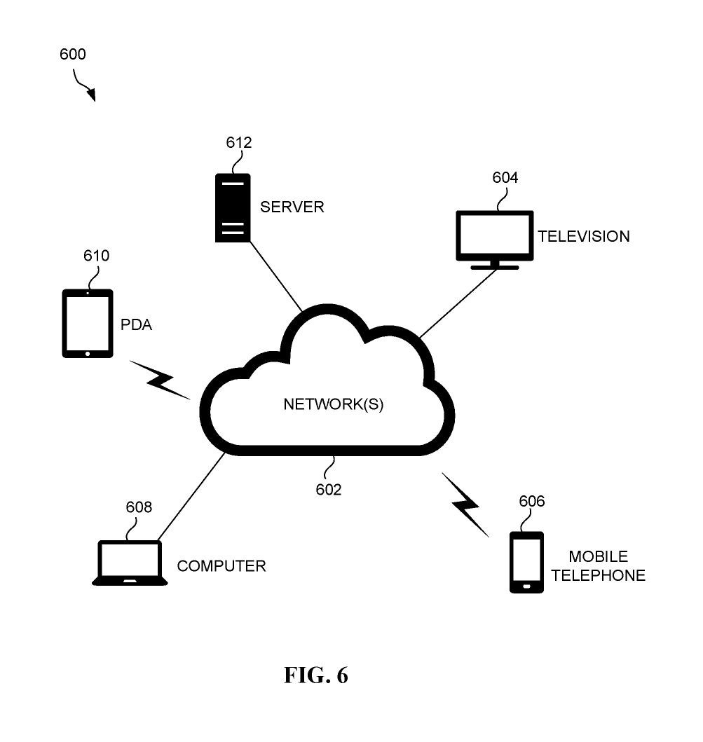

FIG. 6 illustrates a network architecture 600, in accordance with one embodiment. As shown, at least one network 602 is provided. In various embodiments, any component of the at least one network 602 may incorporate any one or more of the features of any one or more of the embodiments set forth in any previous figure(s) and/or description thereof.

In the context of the present network architecture 600, the network 602 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 602 may be provided.

Coupled to the network 602 is a plurality of devices. For example, a server computer 612 and an end user computer 608 may be coupled to the network 602 for communication purposes. Such end user computer 608 may include a desktop computer, lap-top computer, and/or any other type of logic. Still yet, various other devices may be coupled to the network 602 including a personal digital assistant (PDA) device 610, a mobile phone device 606, a television 604, etc.

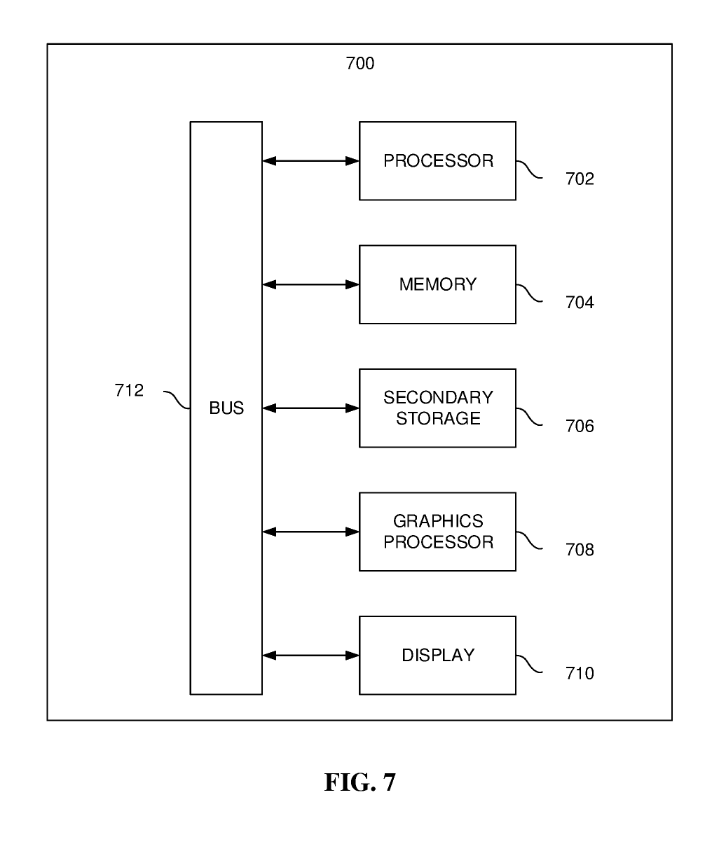

FIG. 7 illustrates an exemplary system 700, in accordance with one embodiment. As an option, the system 700 may be implemented in the context of any of the devices of the network architecture 600 of FIG. 6. However, it is to be appreciated that the system 700 may be implemented in any desired environment.

As shown, a system 700 is provided including at least one central processor 702 which is connected to a bus 712. The system 700 also includes main memory 704 [e.g., hard disk drive, solid state drive, random access memory (RAM), etc.]. The system 700 also includes a graphics processor 708 and one or more displays 710.

The system 700 may also include a secondary storage 706. The secondary storage 706 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 704, the secondary storage 706, and/or any other memory, for that matter. Such computer programs, when executed, enable the system 700 to perform various functions (as set forth above, for example). Memory 704, secondary storage 706 and/or any other storage are possible examples of non-transitory computer-readable media.

In one embodiment, the at least one processor 702 or portions thereof (means) executes instructions in the main memory 704 or in the secondary storage 706 to identify a plurality of frame buffers which are each associated with different parameters. The frame buffers are mapped to a plurality of logical displays, based on the different parameters. A display of contents of the frame buffers mapped to the logical displays is caused utilizing at least one physical display.

Optionally, the frame buffers may each be associated with at least one of a plurality of different applications for generating the contents of the frame buffers.

Optionally, the different parameters may include frame rate, gamma, gamut, resolution, one or more pixel data transmission rate requirements, one or more image processing feature set requirements, and/or a brightness.

Optionally, the frame buffers may be mapped to the logical displays based on the different parameters, by mapping a first one or more of the frame buffers associated with a first parameter to a first one of the logical displays associated with the first parameter, and mapping a second one or more of the frame buffers associated with a second parameter to a second one of the logical displays associated with the second parameter.

Optionally, the frame buffers may be mapped to the logical displays based on the different parameters, by grouping the frame buffers into a plurality of groups, based on the different parameters, and mapping the groups of the frame buffers to the logical displays.

Optionally, image processing may be performed on the contents of the frame buffers. As an option, the image processing may be performed before the frame buffers are mapped to the logical displays. Further, the image processing may be performed based on the logical displays to which the frame buffers are mapped, and/or one or more of the different parameters.

Optionally, composition may be performed on the contents of the frame buffers. Such composition may be performed utilizing a graphics processor and/or dedicated composition hardware. Further, the composition may be performed after the frame buffers are mapped to the logical displays. Still yet, first results of the composition involving a first number of the frame buffers may be combined with second results of another composition involving a second number of the frame buffers.

Optionally, the contents of the frame buffers mapped to the logical displays may be caused to be displayed utilizing different regions of a single physical display. Still yet, the contents of the frame buffers mapped to the logical displays may be caused to be displayed utilizing different physical displays.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

Computer-readable non-transitory media includes all types of computer readable media, including magnetic storage media, optical storage media, and solid state storage media and specifically excludes signals. It should be understood that the software can be installed in and sold with the devices described herein. Alternatively the software can be obtained and loaded into the devices, including obtaining the software via a disc medium or from any manner of network or distribution system, including, for example, from a server owned by the software creator or from a server not owned but used by the software creator. The software can be stored on a server for distribution over the Internet, for example.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein include the one or more modes known to the inventor for carrying out the claimed subject matter. It is to be appreciated that variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A computer-implemented method, comprising:
identifying a plurality of frame buffers each associated with different parameters;
mapping the frame buffers to a plurality of logical displays, based on the different parameters; and
causing a display of contents of the frame buffers mapped to the logical displays utilizing at least one physical display.

2. The method of claim 1, wherein the frame buffers are each associated with at least one of a plurality of different applications for generating the contents of the frame buffers.

3. The method of claim 1, wherein the different parameters include at least one of: frame rate, gamma, gamut, resolution, one or more pixel data transmission rate requirements, one or more image processing feature set requirements, or a brightness.

4. The method of claim 1, wherein the frame buffers are mapped to the logical displays based on the different parameters, by mapping a first one or more of the frame buffers associated with a first parameter to a first one of the logical displays associated with the first parameter, and mapping a second one or more of the frame buffers associated with a second parameter to a second one of the logical displays associated with the second parameter.

5. The method of claim 1, wherein the frame buffers are mapped to the logical displays based on the different parameters, by grouping the frame buffers into a plurality of groups, based on the different parameters, and mapping the groups of the frame buffers to the logical displays.

6. The method of claim 1, and further comprising: performing image processing on the contents of the frame buffers.

7. The method of claim 6, wherein the image processing is performed before the frame buffers are mapped to the logical displays.

8. The method of claim 6, wherein the image processing is performed based on the logical displays to which the frame buffers are mapped.

9. The method of claim 6, wherein the image processing is performed based on one or more of the different parameters.

10. The method of claim 1, and further comprising: performing composition on the contents of the frame buffers.

11. The method of claim 10, wherein the composition is performed utilizing at least one of a graphics processor or dedicated composition hardware.

12. The method of claim 10, wherein the composition is performed after the frame buffers are mapped to the logical displays.

13. The method of claim 10, and further comprising: combining first results of the composition involving a first number of the frame buffers with second results of another composition involving a second number of the frame buffers.

14. The method of claim 1, wherein the contents of the frame buffers mapped to the logical displays are caused to be displayed utilizing different regions of a single physical display.

15. The method of claim 1, wherein the contents of the frame buffers mapped to the logical displays are caused to be displayed utilizing different physical displays.

16. A computer program product comprising computer executable instructions stored on a non-transitory computer readable medium that when executed by a processor instruct the processor to:
identify a plurality of frame buffers each associated with different parameters;
map the frame buffers to a plurality of logical displays, based on the different parameters; and
cause a display of contents of the frame buffers mapped to the logical displays utilizing at least one physical display.

17. A processing device, comprising:
a non-transitory memory storing instructions; and
one or more processors in communication with the non-transitory memory, wherein the one or more processors execute the instructions to:
identify a plurality of frame buffers each associated with different parameters;
map the frame buffers to a plurality of logical displays, based on the different parameters; and
cause a display of contents of the frame buffers mapped to the logical displays utilizing at least one physical display.

18. The processing device of claim 17, wherein the processor includes a graphics processor.

19. A system including the processing device of claim 17, and further comprising the at least one physical display.

20. A system including the processing device of claim 17, and further comprising a plurality of the physical displays.
